(19) United States
(12) Patent Application Publication
(10) Pub. No.: US 2008/0277242 A1
(43) Pub. Date: Nov. 13, 2008

(54) Composite Cement Truck Discharge Chute

(76) Inventors: Thomas John Bruzenak, Salt Lake City, UT (US); Derral Jay Allen, West Valley City, UT (US)

Correspondence Address: THOMAS J. BRUZENAK, 2402 PROMONTORY DR., SALT LAKE CITY, UT, 84109, US

(21) Appl. No.: 11/747,914

(22) Filed: May 13, 2007

(51) Int. Cl. B65G 11/00

(52) U.S. Cl. 193/2 R

(57) ABSTRACT

The Composite Cement Truck Discharge Chute is lightweight and is made of non-porous material having an extremely low coefficient of friction.

### CROSS-REFERENCE TO RELATED APPLICATIONS

U.S. Patent Documents

| | | |
|---|---|---|
| 176700 | April 1876 | Sible |
| 556934 | March 1896 | Koller |
| 2968382 | January 1961 | Oury |
| 3157262 | November 1964 | Chapdelaine |
| 3310293 | Mar. 21, 1967 | Zimmerman |
| 3334872 | August 1967 | Hansen et al. |
| 3774741 | November 1973 | Johnson |
| 4047604 | September 1977 | Daoust et al. |
| 4073318 | February 1978 | Close et al. |
| 4875569 | Oct. 24, 1984 | Oury, et al. |
| 4711334 | Dec. 8, 1987 | Barry, et al. |
| 5015122 | May 1991 | Combes |
| 5035313 | July 1991 | Smith |
| 5178252 | January 1993 | Smith |
| 5192178 | March 1993 | Silbernagel |
| 5551776 | September 1996 | Zimmerman |
| 6186304 | Feb. 13, 2001 | H.ang.kansson |
| 6280119 | Aug. 28, 2001 | Ryan, et al. |
| 20030226737 | Dec. 11, 2003 | Quigley, Thomas P.; et al. |
| 20040154898 | Aug. 12, 2004 | Mc Vay, David Wayne; et al. |
| 6868953 | Mar. 22, 2005 | Thompson |
| 11747906 | May 13, 2007 | Bruzenak |

### STATEMENT REGARDING FEDERALLY SPONSORED RESEARCH OR DEVELOPMENT

Not Applicable.

### REFERENCE TO SEQUENCE LIST, A TABLE, OR A COMPUTER PROGRAM LISTING COMPACT DISC APPENDIX

Not Applicable.

### BACKGROUND OF THE INVENTION

There is a continuing need to advance the state of art in concrete cement mixing truck chute discharge technology. In the past and most recent future, steel, aluminum and fiber-reinforced chutes used similar material though out the chute. Steel chutes weigh approximately 60 pounds and aluminum chutes weigh approximately 40 pounds. Both steel and aluminum chutes have a high coefficient of friction. Some have designed plastic liners to reduce the coefficient of friction. Both steel and aluminum are porous materials allowing concrete to stick and build up in the chute. Both steel and aluminum chutes use wielded constructed techniques and which are subject to fatigue and failure over time.

Today, most mixing trucks still use chutes which weighing about 40 to 60 pounds. There is a need for a chute which radically (1) reduces the coefficient of friction, (2) reduces the weight (3) is non-porous in nature.

The Composite Cement Truck Discharge Chute herein and so claimed is made with fiber-reinforced material, steel material, stain-less steel material, and a ultra high molecular weight (UHMW) polyethylene material having a lower coefficient of friction than steel or aluminum.

### BRIEF SUMMARY OF THE INVENTION

The Composite Cement Truck Discharge Chute (FIG. 1) is made from fiber-reinforced material, steel and UHMW. Three header chutes are connected with a tail chute. The Composite Cement Truck Discharge Chute is lightweight (less than 35 pounds), and is made of non-porous material having an extremely low coefficient of friction.

### BRIEF DESCRIPTION OF THE SEVERAL VIEWS OF THE DRAWING

FIG. 1 is a view of a fiber-reinforced material formed for a cement truck discharge chute with the chute connection/protection assembly attached.

FIG. 2 is an entrance view of a header or a tail chute.

FIG. 3 is an exit view of a header chute.

FIG. 4 is a completed header chute.

FIG. 5 is a completed tail chute.

### DETAILED DESCRIPTION OF THE INVENTION

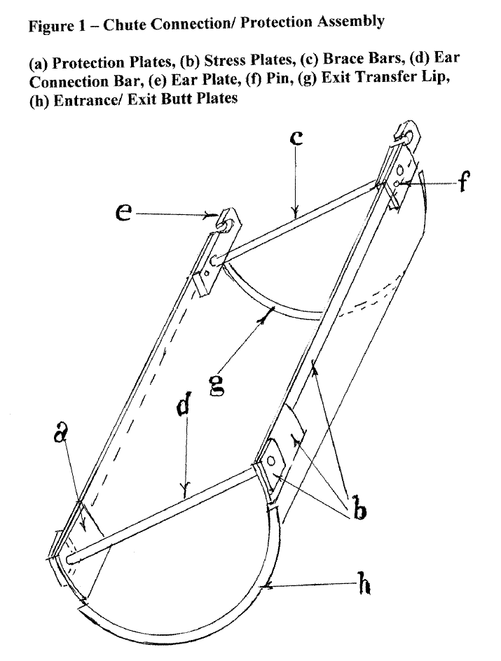

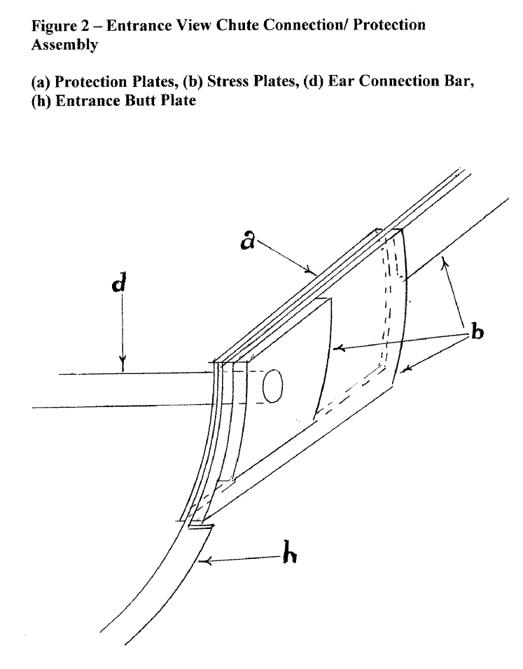

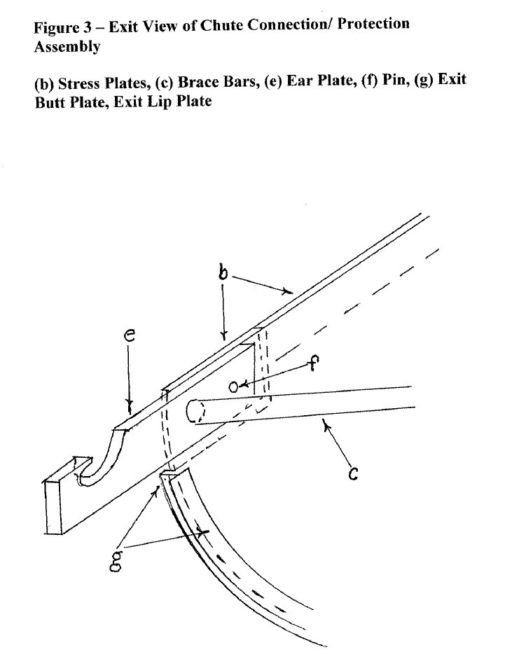

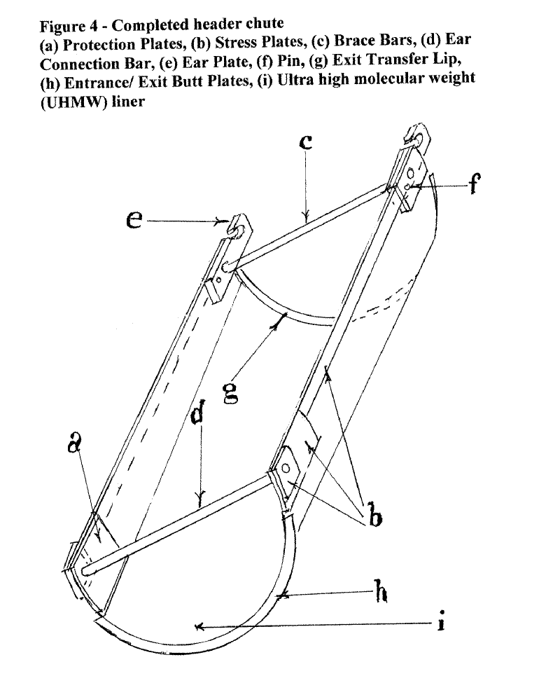

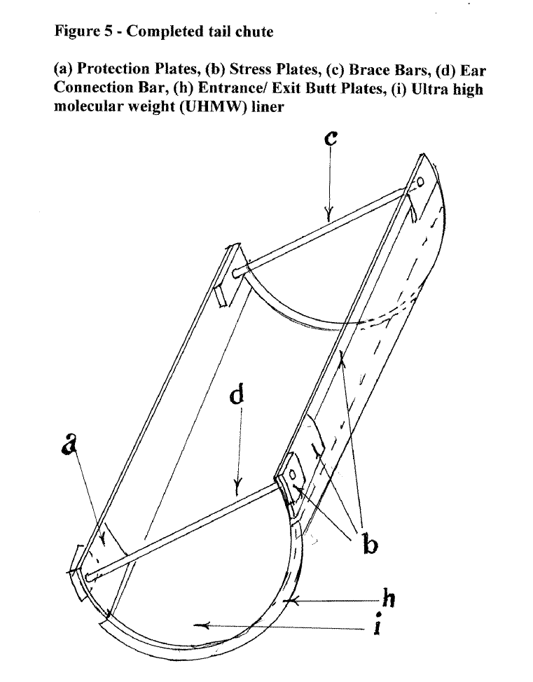

The present invention will become more fully understood from the detailed description herein given below by way of illustration only, and thus do not limit the present invention and wherein:
1. Fiber-reinforced material (non-specific, but of sufficient strength to carry approximately 1,000 pounds of dispersed load, there are many on the market to choose from) is molded utilizing as much as possible of Chute Connection/Protection Assembly patent pending Ser. No. 11/747,906 into a U shaped part approximately 48 inches in length and approximately 14 inches in height and approximately 16 inches in width (FIG. 1).
2. Using the Chute Connection/Protection Assembly patent pending Ser. No. 11/747,906 the chute protection assembly parts not molded are bonded at the entrance and exit of the header chute (FIG. 1).
3. Using the Chute Connection/Protection Assembly patent pending Ser. No. 11/747,906 the chute protection assembly parts not molded are bonded at the entrance of the tail chute (FIG. 2).
4. Using the Chute Connection/Protection Assembly patent pending Ser. No. 11/747,906 the chute connection assembly parts not molded are bonded at the entrance and exit of the header chute (FIG. 2 and FIG. 3).
5. Using the Chute Connection/Protection Assembly patent pending Ser. No. 11/747,906 the chute connection assembly parts not molded are bonded at the entrance of the tail chute (FIG. 2).
6. A ultra high molecular weight (UHMW) polyethylene sheet having a coefficient of friction lower than steel or aluminum is bonded to the inside of the U shaped part of the header and tail chute (FIG. 4 and FIG. 5).

Although a preferred embodiment has been described and shown in the drawings sufficiently to allow those skilled in the art to both build and use my composite cement truck discharge chute, it is to be understood that various modifications may and probably will be practiced in the device, and that these modifications may be made without departing from the spirit of the appended claims.

What is claimed is:

I. The composite cement truck discharge chute (FIG. 1) with Chute Protection Assembly forms a chute ready for the Chute Connection Assembly.

II. The Composite Cement Truck Discharge Chute with Chute Connection Assembly installed forms a header chute (FIG. 2) or forms a tail chute (FIG. 3).

III. A ultra high molecular weight (UHMW) polyethylene sheet having a coefficient of friction lower than steel or aluminum is bonded to the inside of the U shaped chute. (FIG. 1h, FIG. 2h)
